(19) United States
(12) Patent Application Publication
(10) Pub. No.: US 2013/0115024 A1
(43) Pub. Date: May 9, 2013

(54) WELDING PIN AND JOINING ARRANGEMENT FOR THE ALIGNED JOINING OF STRUCTURAL PARTS

(71) Applicants: Joerg Willershausen, Giessen (DE); Klaus Labbe, Undenheim (DE)

(72) Inventors: Joerg Willershausen, Giessen (DE); Klaus Labbe, Undenheim (DE)

(73) Assignee: NEWFREY LLC, Newark, DE (US)

(21) Appl. No.: 13/613,549

(22) Filed: Sep. 13, 2012

(30) Foreign Application Priority Data
Sep. 14, 2011 (DE) 1020110535969

(51) Int. Cl. F16B 41/00

(52) U.S. Cl. CPC F16B 41/002
USPC 411/171

(57) ABSTRACT

A welding pin for the aligned joining of structural parts includes a shank that has a flange; on one side of the flange is a welding end and on the other side of the flange is a fastening section. The welding pin also includes a conical section which is arranged between the flange and the fastening section, and tapers in the direction of the fastening section. The welding pin is suitable for a joining arrangement for the aligned joining of structural parts.

### CROSS-REFERENCE TO RELATED APPLICATIONS

This application claims the benefit and priority of German Patent Application Serial No. 10 2011 053596.9, filed on Sep. 14, 2011, which is incorporated by reference herein.

### BACKGROUND AND SUMMARY

The invention relates to a welding pin for the aligned joining of structural parts, having a shank that has a flange, on one side of the flange a welding end and on the other side of the flange a fastening section. The invention in addition relates to a joining arrangement for the aligned joining of structural parts, wherein a first structural part has at least one welding pin welded by a welding end to the first structural part, which has a shank projecting from the first structural part, a flange arranged on the shank, and on the free shank end a fastening section, and at some distance from the welding pin has a contact surface extending in the longitudinal direction of the welding pin for a second structural part and the second structural part has a fastening opening for accommodation of the welding pin, a supporting surface capable of being applied to the flange and at some distance from the fastening opening a seating surface cooperating with the contact surface.

In automobile construction welding pins, which are welded to a structural part and engage in openings of one or more additional structural parts, frequently are used for joining structural parts which are then fixed to the welding pin by means of nuts or the like for joining the parts. In such joining operations, the problem often exists that the structural parts being joined together must be aligned, so that after joining, they assume a specified end position. This alignment is required in order to be able to compensate for dimensional discrepancies of the parts produced in production and lying within the limit of manufacturing tolerances of the parts and the means for their connection. For example, complicated measurement techniques or gauges are used for alignment of the structural parts. Both may result in the lengthening of joining times and hence in higher production costs.

GB 2,065,011-A discloses a pin for welding to a structural part, which has a cylindrical shank and a cone-shaped foot, the end of which, of greater diameter, is provided with an annular welding surface. There, the cone-shaped foot has the task of enlarging the diameter of the welding surface, so as to give the welded joint greater strength.

The object of the invention is to procure a welding pin and a joining arrangement of the kind mentioned at the beginning, by which the alignment of structural parts being joined is simplified and the time required for joining is reduced. According to the invention, the welding pin for the aligned joining of structural parts has a shank that has a flange, on one side of the flange a welding end and on the other side of the flange a fastening section, while between the flange and the fastening section is arranged a conical section which tapers in the direction of the fastening section. The welding pin according to the invention has the advantage that, in the joining of such parts with the aid of its conical section, at least one structural part to be fastened can be aligned transverse to the longitudinal axis of the welding pin before it reaches its final fastening position on another structural part.

A joining arrangement according to the invention comprises a first structural part that has at least one welding pin welded by a welding end to the first structural part, which pin has a shank projecting from the first structural part, a flange arranged on the shank and, at the free shank end, a fastening section, and at some distance from the welding pin has a contact surface extending in the longitudinal direction of the welding pin for a second structural part, while the second structural part has a fastening opening for accommodation of the welding pin, a supporting surface capable of being applied to the flange and, at some distance from the fastening opening, a seating surface cooperating with the contact surface. The welding pin has adjacent to the side of the flange turned away from the welding end a conical section which tapers in the direction of the fastening section, and the fastening opening of the second structural part has on the supporting surface an inside diameter which corresponds to at least the greatest outside diameter of the conical section, and the second structural part has a region deformable by force, the deformation of which produces a reduction of the distance between the seating surface and the fastening opening.

The joining arrangement according to the invention has the advantage that mutual alignment of the structural parts to be joined takes place automatically upon assembly due to the conical section of the welding pin. Alignment with the aid of gauges or measurements and alignment by hand can be omitted. The risk of alignment errors in assembly is largely avoided. According to the invention, the slope of the conical section, i.e., the difference between the greatest and the smallest radius of the conical section, can be adapted to the maximum manufacturing tolerances that may occur at the distances between the welding pin and the contact surface, on the one hand, and between the fastening opening and the seating surface, on the other. The design of the conical section of the welding pin thus permits, in simple fashion, adaptation of the joining arrangement to the manufacturing tolerances present in each case.

The fastening section of the welding pin preferably is cylindrical and provided with an external thread. The second structural part can therefore be pressed into the alignment position along the conical section by a nut screwed onto the fastening section and then clamped between the nut and the flange. The force required in alignment for deformation of the second structural part can therefore be brought to bear indirectly by turning of the nut and requires no significant external force.

The welding pin preferably is welded to the first structural part so that the flange is arranged at some distance from the first structural part. Contact of the second structural part on the flange, which determines the fastening position of the second structural part on the welding pin, is thereby ensured. The seating surface of the second structural part can rest directly on the contact surface of the first structural part, but it may alternatively be provided that between the seating surface and the contact surface, there is arranged a section of a third structural part, which is inserted in the joining operation.

### BRIEF DESCRIPTION OF THE DRAWINGS

The invention will be explained in detail below with reference to an exemplary embodiment represented in the drawing, wherein:

FIG. 1 shows a welding pin according to the invention;

FIG. 2, a joining arrangement according to the invention; and

FIG. 3, a cross section of the joining arrangement of FIG. 2.

### DETAILED DESCRIPTION

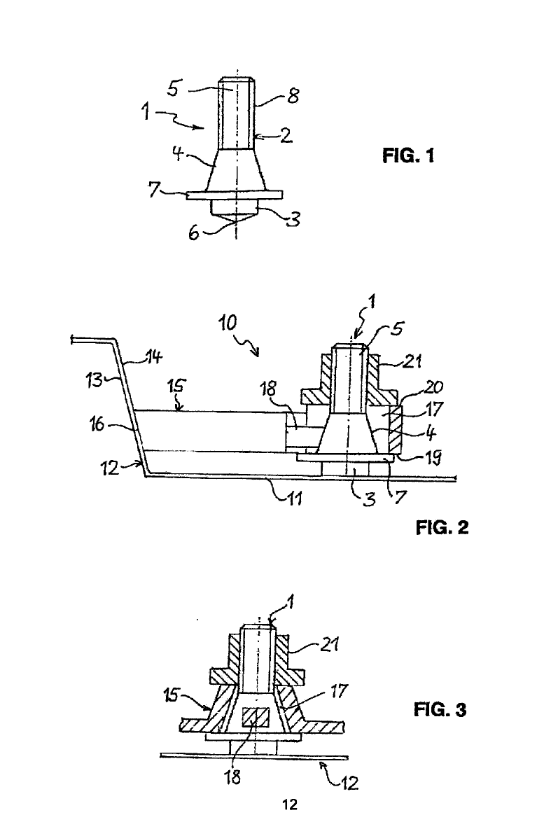

The welding pin 1 shown in FIG. 1 has a shank 2, extending along an axis, which forms a welding end 3, a conical section 4 and a fastening section 5. The welding end 3 is cylindrical and has an ignition tip 6. A disk-like flange 7 is formed on the shank 2 between the welding end 3 and the conical section 4. The flange 7 with its side turned toward the conical section 4 forms a flat contact surface for a structural part to be fastened. The conical section 4 with its greatest outside diameter adjoins the flange 7 and tapers in the direction of the fastening section 5 all the way to the outside diameter of the latter. The fastening section 5 is cylindrical and has an external thread 8.

FIG. 2 shows a joining arrangement 10 with a welding pin 1 of FIG. 1. The pin 1 is welded by its welding end 3 to a plate-like flat section 11 of a first structural part 12 and projects substantially perpendicular from the section 11. At some distance from the welding pin 1, the first structural part 12 has a step 13, which forms a contact surface 14 extending beside the welding pin 1. The contact surface 14 is designed for the contact of a second structural part 15 and serves as a reference surface for positioning of the second structural part 15 with respect to the first structural part 12. The second structural part 15 has a seating surface 16 cooperating with the contact surface 14, which after joining should rest on the contact surface 14. For fastening to the welding pin 1, the second structural part 15 has an opening 17, in which the welding pin 1 engages. The opening 17 is limited in the direction of the seating surface 16 by an element 18, which by the action of a force in the direction of the seating surface 16 is deformable or displaceable with respect to the second structural part 15, so as to produce an enlargement of the diameter of the opening in this direction and hence a reduction in the distance between the element 18 and the seating surface 16. The second structural part 15, in a region surrounding the opening 17, in addition has a supporting surface 19, by which it is capable of being supported on the flange 7. On the side opposite the supporting surface 19, the structural part 15 has a contact surface 20 for a nut 21 screwed onto the welding pin 1.

For fastening of the second structural part 15 to the first structural part 12, the second part 15 is first roughly arranged with respect to the first part 12 and slipped by the opening 17 onto the welding pin 1, whereupon the seating surface 16 rests on the contact surface 14 and the element 18 comes into contact with the conical section 4. If, in connection with the permissible manufacturing tolerances, the distance between the contact surface 14 and the welding pin 1 has a maximum value and the distance between the seating surface 16 and the element 18 has a minimum value, the structural part 15 is able to reach all the way to contact on the flange 7 without significant force, while the conical section 4, by contact with the element 18, provides that the seating surface 16 also rests on the contact surface. If, on the contrary, the distance between the contact surface 14 and the welding pin 1 is smaller than the maximum value and/or the distance between the seating surface 16 and the element 18 is greater than the minimum value of the respective tolerance, the element 18 comes into contact with the conical section 4 before the structural part 15 with its supporting surface 19 reaches the flange 7. Then, with the aid of the nut 21 screwed onto the welding pin 1, the structural part 15 can be pressed downward against the resistance of the element 18 all the way to contact on the flange 7. The element 18 is thereby forced against its resistance with respect to the structural part 15 in the direction of the seating surface 16, whereupon the seating surface 16 is firmly pressed onto the contact surface 14. In both of the cases described, the conical section 4 of the welding pin 1 thus causes the second structural part 15 to be positioned in the desired fashion with respect to the first structural part 12 and fixing in the positioned position takes place.

The invention claimed is:

1. A welding pin for the aligned joining of parts, comprising a shank that has a flange, on one side of the flange a welding end and on the other side of the flange a fastening section, and a conical section arranged between the flange and the fastening section tapering in the direction of the fastening section.

2. The welding pin according to claim 1, wherein the fastening section is cylindrical and has an external thread.

3. The welding pin according to claim 1, wherein the fastening section further comprises a substantially cylindrical base coaxially aligned with the shank, and a substantially conical and central welding tip, the flange radially protruding larger than the adjacent base and conical section, and the welding pin being an automobile welding pin.

4. The welding pin according to claim 1, wherein a portion of the conical section contacting the flange has a larger diameter than a largest diameter of the fastening section.

5. The welding pin according to claim 1, further comprising:
one of the parts is an automobile part including a tapered inside surface defining at least a portion of an opening, the opening of the part being removably received upon the conical section such that the tapered inside surface and an offset surface of the part contact against the conical section and flange, respectively; and
a removeable nut engaging with threads on the shank to push the part against the flange.

6. The welding pin according to claim 5, wherein the nut includes a laterally extending flange which is laterally larger than the largest diameter of the conical section.

7. A welding pin comprising:
a threaded shank elongated in an axial direction;
a substantially conical shoulder adapted to removably receive a laterally elongated automotive part thereagainst;
a flange intersecting directly against and having a greater diameter than a largest diameter portion of the conical shoulder;
a substantially cylindrical base projecting from an opposite side of the flange than the conical shoulder, the base having a smaller diameter than both the flange and the largest diameter portion of the conical shoulder; and
a substantially conical welding tip centrally located on the base opposite the flange, prior to welding.

8. The welding pin according to claim 7, further comprising a nut removeably engaging the shank, the nut compressing the automotive part against the flange.

9. The welding pin according to claim 8, wherein the nut includes a laterally extending flange which is laterally larger than both the largest diameter portion of the conical shoulder and the base.

10. The welding pin according to claim 7, wherein the base is axially shorter than the conical shoulder and the welding tip is axially shorter than the conical shoulder.

11. A welding pin assembly comprising:
(a) a welding pin comprising:
an axially elongated shank;
a substantially conical shoulder;
a laterally enlarged flange; and
a welding end, the flange being located between the conical shoulder and the welding end;
(b) a first structural automobile part to which the welding end of the weld pin is welded;
(c) a second automobile part including an opening and a localized seating finger projecting into the opening, the seating finger having a tapered distal end contacting against the conical shoulder of the weld pin, a portion of at least one inner surface defining the opening being spaced away from the weld pin when fully assembled; and
(d) a fastener engaging the shank and compressing the second part against the flange of the weld pin.

12. The weld pin assembly according to claim 11, wherein the welding end further comprises a cylindrical base immediately adjacent the flange, and a substantially conical welding tip centrally projecting from the base.

13. The weld pin assembly according to claim 12, wherein the base is axially shorter than the conical shoulder and the welding tip is axially shorter than the conical shoulder.

14. The weld pin assembly according to claim 12, wherein the fastener is a threaded nut which includes a laterally extending flange that is laterally larger than both the largest diameter portion of the conical shoulder and the base.

15. The weld pin assembly according to claim 11, wherein the first part includes a section angularly offset from that to which is welded the weld pin, and the second part includes a laterally elongated body and a contacting surface facing away from the distal end of the seating finger, the contacting surface contacting the offset section of the first part such that the second part is deformable if a distance between the conical shoulder of the weld pin and the offset section of the first part is less than a distance between the distal end and the contacting surface of the second part.

16. The weld pin according to claim 11, wherein side walls of the second part, defining at least portions of the opening, are tapered to substantially match an angle of the conical shoulder of the weld pin, the seating finger is spaced between the side walls and the seating finger has a longer length toward the weld stud than width and height.

17. A joining arrangement comprising at least one welding pin welded by a welding end to a first structural part, which pin comprises a shank, a flange arranged on the shank and, at the free shank end, a fastening section, and the first structural part comprises a contact surface generally extending in a longitudinal direction of the welding pin, and a second structural part comprising a fastening opening for accommodation of the welding pin, a supporting surface capable of being applied to the flange and, at some distance from the fastening opening, a seating surface cooperating with the contact surface, the welding pin adjoining the side of the flange turned away from the welding end further comprising a conical section which tapers in the direction of the fastening section and the fastening opening of the second structural part on the supporting surface having an inside diameter which corresponds to at least the greatest outside diameter of the conical section, and the second structural part further comprising a region deformable by force, the deformation of which produces a reduction of the distance between the seating surface and the fastening opening.

18. The joining arrangement according to claim 17, wherein the difference between the greatest and the smallest radius of the conical section corresponds to the maximum manufacturing tolerances that may occur in the distances between the welding pin and the contact surface, on the one hand, and/or between the fastening opening and the seating surface, on the other.

19. The joining arrangement according to claim 17, further comprising a nut, wherein the fastening section of the welding pin is cylindrical and has an external thread and the second structural part is clamped between the nut screwed onto the fastening section and the flange.

20. The joining arrangement according to claim 17, wherein the flange is arranged at some distance from the first structural part.

21. The joining arrangement according to claim 17, wherein the seating surface rests on the contact surface.

22. The joining arrangement according to claim 17, wherein between the seating surface and the contact surface is arranged a section of a third structural part.
